(19) United States
(12) Patent Application Publication
(10) Pub. No.: US 2007/0292834 A1
(43) Pub. Date: Dec. 20, 2007

(54) Method and system for establishing compatibility between potential students and universities

(76) Inventor: Paul Ransdell, Berea, KY (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 11/442,891

(22) Filed: May 30, 2006

(51) Int. Cl. G09B 3/00

(52) U.S. Cl. 434/350

(57) ABSTRACT

A system and method for evaluating the compatibility of a prospective student with participating universities is disclosed. The system presents questions, and a specific set of answers to those questions, to universities for rating of importance. The universities rate each question and each answer to create a student profile. A prospective student responds to the set of questions, with the option of selecting more than one answer to some questions. Based on the students responses, the method uses the ratings provided by the universities to calculate a compatibility score. The compatibility score allows the student's compatibility level with each university to be compared, with higher scores indicating greater compatibility. The student is informed of the universities with the greatest compatibility and given contact information. Those universities are also informed and given student contact information. The method can be implemented with a computer, or over a computer network, including the Internet.

### FIELD OF THE INVENTION

This invention relates generally to a method of evaluating the compatibility between a prospective student and various participating universities, colleges, other institutions, or other educational venues. More specifically, the method includes having participating universities rate in importance, questions and specific answers to those questions to create student profiles, then presenting the questions to prospective students for responses, and using the university ratings and student responses to determine compatibility.

### BACKGROUND OF THE INVENTION

The college selection process for prospective students is a daunting endeavor. A prospective student has limited knowledge of what educational opportunities are available to them, let alone knowledge of details about all of the institutions providing those opportunities. In conjunction with the general lack of knowledge, there is the difficulty of effectively weighing and comparing different factors. A student must consider and weigh such factors as cost, location, educational opportunities, social opportunities, monetary assistance, academic rigor, as well as many other factors. In making an evaluation, a student must also consider qualities that an institution must have versus those qualities that are really only preferences for the student. This is a difficult and multifaceted decision.

Educational institutions, or universities for brevity, face a similar information problem as do prospective students. Universities desire qualified students that will be successful attending their university, but do not automatically have contact information or preference profiles for prospective students. Universities would like to target prospective students that are academically suited to them and to target prospects that are interested in other aspects of the university, such as size, social opportunities, etc. Also, different departments in a university may have different needs for prospective students. While universities can obtain bulk lists of prospective students, it is not effective or efficient to contact every student, and the bulk lists do not provide student qualifications and preferences.

There are several needs which need to be met. Prospective students need information and assistance in weighing competing factors. Universities need information and the ability to attract students that fit a profile that a university believes will be successful, and different departments in the universities need to address different requirements. In general, both the prospective student and university need information and assistance in evaluating compatibility between the prospective student and university.

### DESCRIPTION OF PRIOR ART

U.S. Pat. No. 6,915,269 B1 by Shapiro et al., discloses a system that accommodates bilateral and multilateral decision-making. The bilateral decision-making comprises the situation where two distinct parties, a party and a counterparty, have inputs into the decision-making process. The party and the counter-party create profiles of what they are looking for in a decision-making situation and the system in Shapiro uses conjoint analysis to evaluate how well their profiles agree with each other. Multiple party and multiple counterparty profiles can be evaluated together to determine best agreements of profiles. The multilateral decision-making is an additional embodiment where a co-evaluator is included to give the party or counterparty an additional perspective by creating a profile based on the co-evaluator's observations of the needs and preferences of the one they are assisting.

U.S. Pat. No. 6,012,051 by Sammon, Jr., et al, claims a consumer profiling system with an analytic decision processor. Sammon is meant to assist a consumer in making a complex decision such as purchasing a house, a car, or even selecting a university. Several different data types can be entered by a person using the system. These data types include: a numeric type for a numeric evaluation of an attribute; a Boolean type, an enumerated type for selecting from a list, an option type for including or eliminating a feature, and a ranged numeric type for providing a value over a range of values. Sammon provides several examples of how this data may be entered. The data may be organized into a hierarchy and then converted to a vector representation. At the final vector level, the data is normalized to a 0-1 range. The characteristics of the individual products that a consumer is considering is also represented by a vector. To assist the consumer in making a decision, the decision engine of the invention then compares the similarity of the vector developed from the consumer's preferences and the vector of characteristics of the products.

U.S. Pat. No. 6,826,541 by Johnston, et al, is directed to assisting a person in making a decision among several complex alternatives. A person making a choice is presented with several features that they can choose from as being important to them. Also, the person making the decision is presented with several pairs of items having different levels of quality with respect to a particular feature. By forcing the user to choose between these two items, the program attempts to further refine the information that the user puts into the program. An example where a consumer might choose between two separate qualities of an item might be a “high price with high quality” versus “low price and low quality” where specific dollar amounts are assigned to the prices. The results from the user's choices are entered into a single column vector. A multi-column and multi-row matrix is used to store the order in which the consumer entered the information or was asked the information. Once the matrices are established, various techniques may be used to process the information. These techniques include regression analysis as well as least squares methods. These methods produce unitless numbers which are interpreted to reveal the level of utility of a particular choice for the consumer.

U.S. Pat. No. 6,289,340 by Puram et al, is a program that matches candidates with positions. A profile of the candidate is generated in terms of skills and abilities and a profile for the position is generated which includes core skills required and additional skills desired. The profiles are evaluated by first selecting a sub pool of candidates which have the required skills for the position. From there, a candidate's additional skills are further evaluated with respect to the profile of the position based on desired skills for the position. When generating a profile on a candidate, his or her proficiency in various skills is rated and recorded in the profile. The person trying to fill a position also rates the desired level of proficiency for the position. To further narrow the search, these ratings for that skill are compared between the candidate and the position. The software develops an overall score based on how well matched the candidates level of skill is for the requirements of the position. If a candidate has a much higher level of competency in a skill than is required by the position, their competency level is set for maximum score at that skill.

### SUMMARY OF THE INVENTION

The present invention provides a method and system of establishing compatibility between a prospective student and a narrowed selection of colleges, universities, or other educational venues from a larger set of such institutions. In one embodiment, the method is applied over the Internet and uses question surveys to evaluate both the preferences and qualifications of the prospective student and the preferences and qualifications of the universities present in the full set of universities.

A participating university accesses a website, and creates an account, and creates a profile. The profile created by the university includes information about the university as well as information about the type of student that the university is seeking. Different academic areas of a university may very well create different student profiles, and different student profiles may be created to target specific sets of students for a university.

A prospective student also accesses a website, creates an account, and fills out a survey of biographical information, qualifications, and preferences. The biographical information includes such things as age range, address, and current educational status. The qualifications information includes test scores and other accomplishments. The preferences portion of the survey elicits preference responses in regards to college size, town size, activities, degrees offered, etc. Some preferences may be absolute requirements. This information is used to generate a profile for evaluation.

When creating a profile, the university rates the importance of a question, and each possible response to that question is also rated by the university. In one particular embodiment, these ratings have a range of 0-5. For example, a university trying to maintain a highly traditional undergraduate student body might rate the age question very highly and then highly rate the answer indicating the traditional age range for a high school junior or senior or college freshman. Alternatively, a university seeking non-traditional students might rate the age question highly, but highly rate responses indicating non-traditional age ranges. A university with a particular religious affiliation could rate both the religion question and a particular response highly, etc. The ability to rate a question or answer with a zero allows a university to give a question or answer a null value, so that the question or answer has no effect on the compatibility score.

The profile created from the prospective student's responses is evaluated in comparison to the university profiles to determine the degree of compatibility between students and universities. In one embodiment, to provide the most focused information, only the top four universities with the best compatibility with the student profiles are identified to the students. These four universities are also notified of the high compatibility with the prospective student's profile. This assists universities in identifying potential students that more closely match the university's needs. The universities are made aware of new student matches on a near real time basis. Whenever a university checks its account, updated information is available.

In one embodiment of the invention, the universities gain access to the website after paying a subscription fee and creating an account. The account and fees may be based on a time frame, a threshold of number of student matches, or other metric. Access is free to the students.

There are two types of questions in the profile survey, absolute questions and factor questions. The absolute questions elicit responses from students indicating what the university must have from the perspective of the student. The factor questions indicate what characteristics a prospective student would prefer a university to have. The university in turn places varying values on factor questions to indicate preferences from the university's perspective.

When creating its preferred student profile, a university rates the importance of the question from 0-5 and then rates, from 0-5, the value of each possible answer for a match. Having set values for each question and each possible answer to each question, a university has essentially set up an exam tailored to each university. The degree of compatibility between the student generated profile and the university generated profiles is scored by first normalizing the possible contribution from each question and possible answer. This normalization for each question is accomplished by summing the values assigned to all the questions and dividing the value for a question by the sum. Similarly, normalizing each possible response consists of summing the values assigned to the responses to a question and then divided each response value by the sum. For each response a student selects, its normalized value is multiplied by the normalized value for its question and added to the score. A score between a student and each university is calculated.

Once a student's scores are determined with respect to all universities, the universities' profiles are evaluated in view of the student's stated absolute requirements. Universities that do not have the characteristics that a student indicates as required are removed from consideration. Examples of absolute requirements would be maximum tuition rates and the state where a university is located, although these would not necessarily have to be required characteristics for all embodiments. Of the universities remaining in contention, those having the top four scores are identified and made known to the student. The students information is also provided to each of the four universities. If there is a tie that causes more than four universities to be in contention, a tie breaker is used to reduce the number to four. If four or more universities do not meet the absolute requirements of the student, one of those requirements is relaxed to add some universities back into consideration. These added universities are evaluated for high scores and the needed number is added to acquire the desired total of four.

Accordingly, those skilled in the art will appreciate that the conception upon which this invention is based may readily be utilized as a basis for other methods and systems for carrying out the purposes of the present invention. It is important, therefore, that the claims be regarded as including such equivalent constructions insofar as they do not depart from the spirit of the present invention. In particular, the use of specific numbers to illustrate quantities and arithmetic operations should not be seen as limitations of the form of the invention.

Furthermore, the purpose of the foregoing Abstract is to enable the U.S. Patent and Trademark Office and the public generally, and especially including the practitioners in the art who are not familiar with patent or legal terms or phraseology, to determine quickly from a cursory inspection, the nature and essence of the technical disclosure of the application. The Abstract is neither intended to define the invention of the application, nor is it intended to be limiting to the scope of the invention in any way.

### BRIEF DESCRIPTION OF THE DRAWINGS

Additional utility and features of the invention will become more fully apparent to those skilled in the art by reference to the following drawings, which illustrate the primary features of the preferred embodiment.

FIG. 1 shows a flow chart of the profile construction process for both parties for scoring for one embodiment of the present invention.

FIG. 2 illustrates a network or Internet oriented embodiment of the present invention.

FIG. 3 shows a sample set of questions as seen by a university.

FIG. 4 shows a sample set of questions as seen by a prospective student.

FIG. 5 illustrates the calculation of the scores.

### DETAILED DESCRIPTION OF THE PREFERRED EMBODIMENT

The detailed description below is for preferred embodiments and is intended to explain the current invention. It is to be understood that a variety of other arrangements are also possible without departing from the spirit and scope of the invention. Where appropriate, the same numbering will be used when discussing different embodiments.

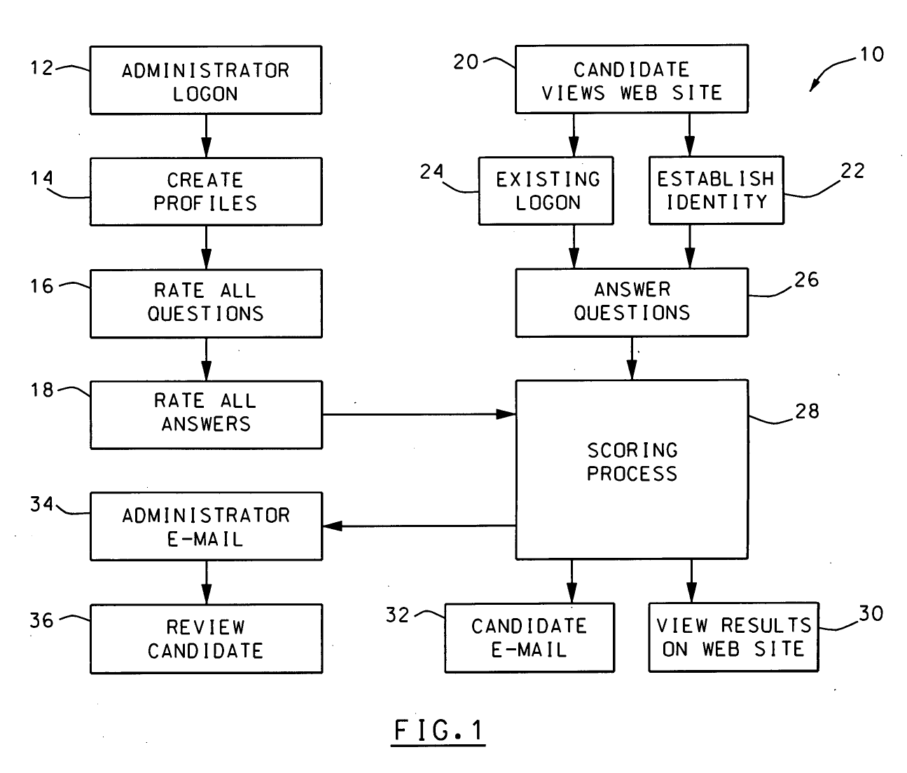

The flow chart of FIG. 1 shows the steps taken by both the university representative, indicated as the Administrator, and a prospective student, indicated as the Candidate, as well as the scoring and notification process. An initial step for the university Administrator is to log-in 12 to the program 10. From there the Administrator can begin to interact with the system to establish requirements and profile characteristics.

A set of requirements and profile characteristics is identified as a profile. First the Administrator identifies a new profile 14 then begins to establish its characteristics. The system 10 presents a set of questions to the administrator. These are questions that will also be presented to potential students and which have a specific set of answers already identified. The Administrator rates, at 16, the importance of the questions with a rating from 0-5. The Administrator also rates from 0-5 each of the possible answers to the questions as indicated at 18. In one embodiment, the questions and their answers are presented to the Administrator together. Other embodiments might require an Administrator to rate all the questions before presenting the answers to the questions for rating. With the rating of the questions and answers, a university has established a profile. The system collects profiles from all the participating universities.

A student's initial interaction with the system begins when the student views the web site 20. If it is the first time for the student to use the system, a student identity must be created 22 and established on the system. If the student has already established an identity, the student may simply log on 24. Once the student is logged onto the system, the student is presented with the same set of questions and answers that the universities rated to create their prospective student profiles. The student answers the questions 26 to create a profile. This profile is evaluated for compatibility with respect to each participating university through a scoring process 28 discussed in more detail later. This scoring process evaluates the students answers in light of the profiles created by the universities to calculate a score for the student for each university. Once the scores are calculated, higher scores indicate higher compatibility between the prospective student and a university.

In addition to the numerical scoring aspects of the questions, there are two types of questions in the profile survey, absolute questions and factor questions. The absolute questions elicit responses from students indicating what the university must have from the perspective of the student. The factor questions indicate what characteristics a prospective student would prefer a university have. The absolute questions provide an additional screening means to make sure a university or institution has all that a student considers to be absolutely required as opposed to just preferred. Universities that do not have the characteristics that a student indicates as required are removed from consideration. Examples of absolute requirements would be maximum tuition rates and the state where a university is located. Of the universities remaining in contention, a pre-set number of those at the high end of the scoring are identified and made known to the student. The students information is also provided to each of the identified universities. If there is a tie that causes more than the pre-set number of universities to be in contention, a tie breaker is used to reduce the number to what is needed. If not enough universities meet the absolute requirements of the student to fill the pre-set number, one of those requirements is relaxed to add some universities back into consideration. These added universities are evaluated for high scores and the needed number is added to acquire the desired pre-set total.

After the compatibility scores are established, the parties can be notified of the results. The student is informed of universities with which a high compatibility is shown and those universities are also informed. In one embodiment, the student is only notified of a limited number of universities with which there is a high score of compatibility, for example, the four highest scoring universities. If the student is operating over the Internet, links to university contacts can be provided as well as links to university web sites. Each university that is identified to the student is also informed of the high score of compatibility and is given student contact information. For the student, the results can be displayed immediately and/or sent by e-mail. For the university, the results may be forwarded by e-mail and/or stored until the next time the university representative logs on to the system.

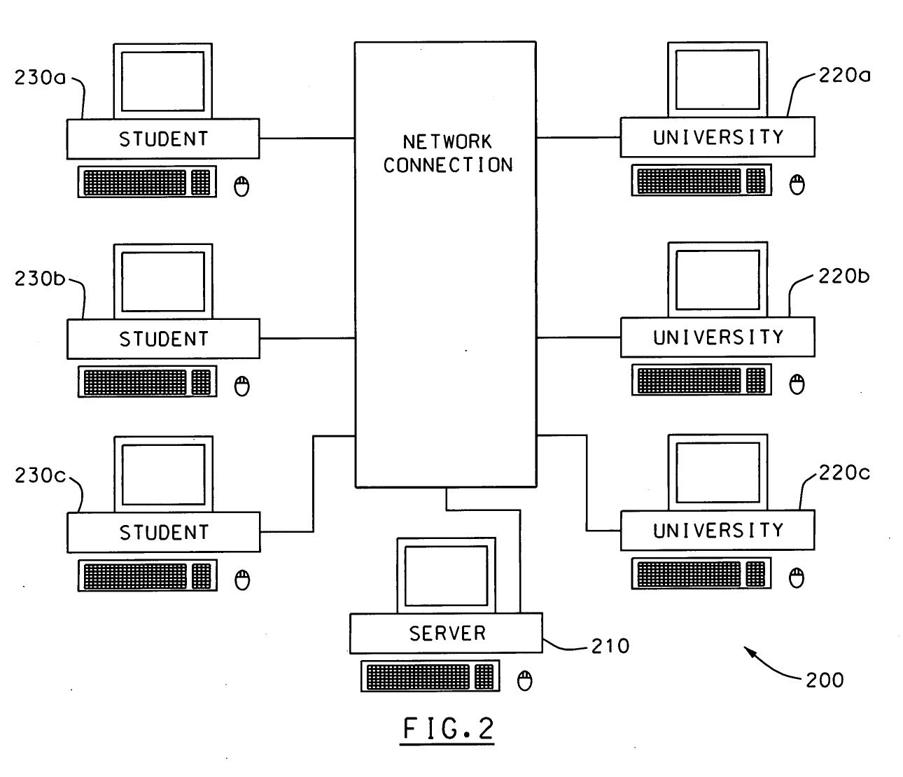

FIG. 2 shows a network embodiment 200 of the present invention, in particular a Internet connected network. A server 210 includes a processor and storage capabilities. Computer instructions specific to the computer application embodiment are programmed into the processor. The storage capabilities are sufficient to hold databases of university information, including ratings of the questions and answers, and prospective student information including responses to the questions. Server 210 would also have computer instructions appropriate to communicating with other computers over a network, such as the Internet. Information can be entered into server 210 via any typical electronic communication device used with computers such as keyboard, computer mouse, touch screen, etc. The storage capabilities may consist of such computer memory as floppy disks, conventional hard disks, CD-ROM, Flash ROMS, non-volatile ROM, RAM, and CD-RW.

FIG. 2 shows several computers 220a, 220b, and 220c, accessible by university administrators. Computers 220a-c would have computer instructions programmed into their processors necessary to communicate with other computers available to the network. It would not be necessary for computers 220a-c to have programming specific to the embodiment of the invention. Information can be entered into computers 220a-c via any typical electronic communication device used with computers such as keyboard, computer mouse, touch screen, etc.

FIG. 2 also shows several computers 230a, 230b, and 230c, accessible by prospective students. Computers 230a-c would have computer instructions programmed into their processors necessary to communicate with other computers available to the network. It would not be necessary for computers 230a-c to have programming specific to the embodiment of the invention. Information can be entered into computers 220a-c via any typical electronic communication device used with computers such as keyboard, computer mouse, touch screen, etc.

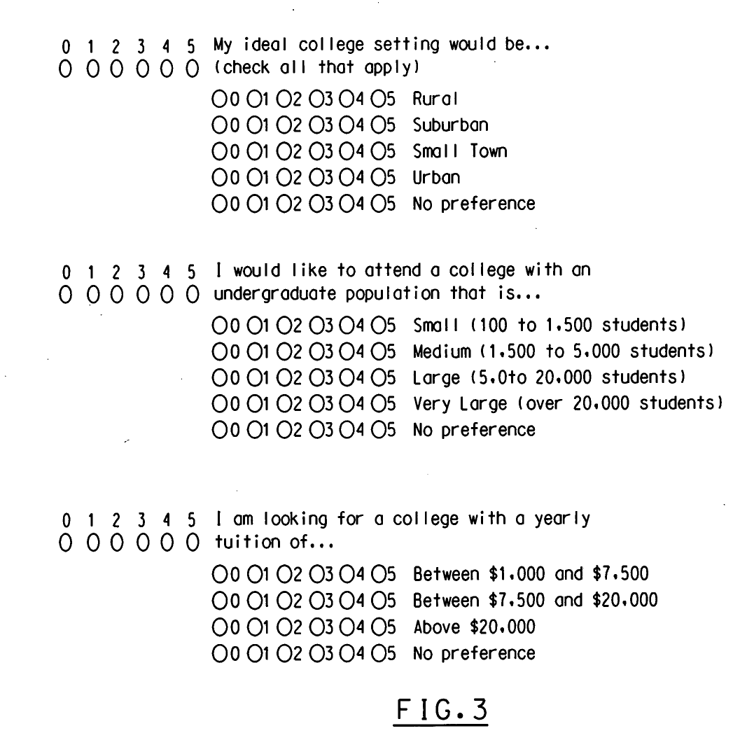

FIG. 3 shows a sampling of questions, predetermined answers, and how they may be presented to a university administrator. To the left of the questions are circles with numerical values next to them. A university administrator or representative selects one of these circles to rate the question in importance for their profile. Similarly the answers to the questions are rated by selecting appropriate circles. The circles may be selected by a mouse, keyboard directed cursor movements, or other method common to computers. Once a university has rated all the questions and answers, it has created a profile that can be used to evaluate student-to-university compatibility.

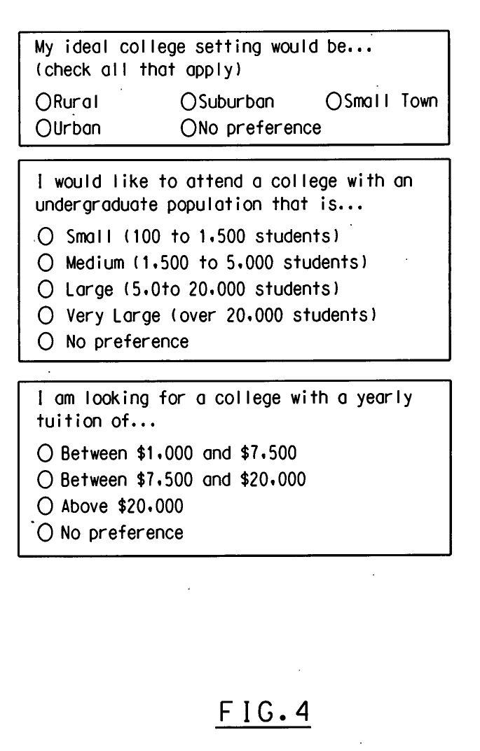

FIG. 4 shows a sampling of questions, predetermined answers, and how they may be presented to a prospective student. As presented to the prospective student, the questions and answers do not have the rating values and circles, but rather only have circles to indicate whether they have been selected. The circles may be selected by a mouse, arrow directed cursor movements, or other method common to computers. For some questions, it is appropriate to select more than one answer.

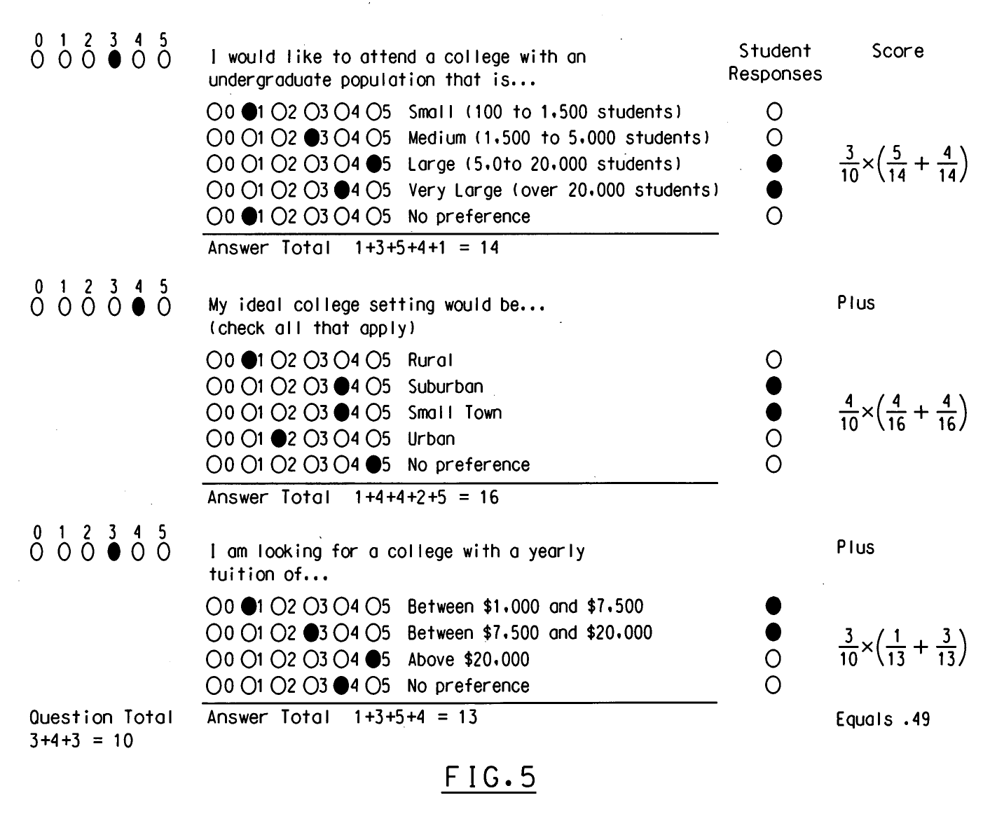

FIG. 5 shows an example of how student responses are processed to derive a score used to compare the compatibility of a prospective student with participating universities. Along the far left are rating circles next to respective questions. Below the questions are answers which also have rating circles next to them. Each set of rating circles has at least one value chosen for the scoring example. To the right of the questions are answer circles for students. Some of these circles are selected as sample responses from a student. So, FIG. 5 shows the questions and answers with their university assigned values, as well as sample responses by a student. Sample calculations in FIG. 5 illustrate the scoring algorithm applied to these sample question and answer ratings of a university and sample responses by a student.

At the bottom left of FIG. 5, the sum of the question values is calculated. This sum is used to calculated a normalized question value by multiplying 1 divided by the question value sum by the individual question values. This quotient appears as the first term in calculations at the far right of each question.

Beneath each question and its set of answers, an answer total is calculated. This answer total is used to calculate a normalized answer value by multiplying 1 divided by the answer value sum by the respective individual answer values. The answers chosen by a student determine which normalized answer values are used to calculate the score.

Looking at the student responses to the question at the top of FIG. 5, it can be seen that two answers were selected, one having a value of 5 and another having a value of 4. Out to the right of this question a calculation is performed multiplying the normalized question value times the sum of each of the selected answer values normalized by the answer total. So, the value for one response, 5, is divided by the answer total, 14, and added to the value of the other response, 4, which is also divided by the answer total, 14, and this sum is multiplied by the normalized question value, which is 3 divided by the question total, 10. The same calculation is made for each question as answered by the student and added together to reach a final score which is displayed at the bottom right of FIG. 5. Due to the communicative and associative nature of the arithmetic, the calculations may be made in slightly different groupings without changing the outcome. If a university values a question or answer at “0”, that question or answer is nullified from the scoring process since it cannot contribute to the final score.

Once the numerical scores are calculated, the absolute requirement screens are applied to remove universities not meeting the student's requirements. Of the universities left, the compatibility between a prospective student and universities is evaluated by considering the higher the score the higher the degree of compatibility. In one embodiment, limited pre-set number of universities is identified from the top scores. This helps the prospective student narrow his search, while providing tighter profile compatibility for the universities' outreach. If there are ties in scores which cause the pre-set number to be exceeded, a tie breaker is employed. If more universities are needed to fill the pre-set number, one of the absolute requirements for the student is relaxed, and a sufficient number of the top scorers among the resulting added universities is chosen to complete the pre-set number.

After the prospective student fills out the survey and the scores are tabulated, the student is notified of which universities were more compatible with the student responses. This may be done immediately on the computer screen the student is using, via e-mail, both, or other means. Likewise, the appropriate person at the compatible universities is informed, and this may be accomplished in several ways, also. In one embodiment, the information for compatible prospective students is stored in the system until the next time a university administrator logs in.

Having provided detailed descriptions of several embodiments, it can readily be seen by one skilled in the art that the present invention has broad scope. Specific numerical examples, sample questions, etc. should not be understood as limiting the scope of the invention. Also, while the term “university” was widely used throughout the specification, it should be understood that the invention could be applied with a wide range of institutions including colleges and other educational institutions, educational programs, or other educational venues and that “university” should not be a limitation.

I claim:

1. A method for measuring the compatibility of potential students and participating educational venues, comprising;
creating a set of questions;
creating a specific set of answers to each said question;
obtaining from each said educational venue a numeric value for each said question and a numeric value for each said answer to each said question;
for each said educational venue, determining a normalized question value for each said question by dividing the value assigned to said question by said educational venue by the sum of all the values assigned to said questions by said educational venue;
for each said educational venue, determining a normalized answer value for each said answer by dividing the value assigned to said answer by said educational venue by the sum of all the values assigned to said answers to a respective question;
obtaining from a potential student responses to said set of questions;
calculating a score for said student for each said educational venue by summing the products of the normalized question value for each said question multiplied by the normalized answer value of each answer selected for a respective question by said student, and;
ranking the educational venues by this score.

2. The method of claim 1, further comprising:
conveying to said student the identities of a predetermined number of said educational venues with the highest relative rank.

3. The method of claim 2, further comprising:
conveying to said predetermined number of said educational venues with the highest relative rank, the student's identity and contact information.

4. The method of claim 1, wherein said questions pertain to topics from the following list:
biographical information about the student;
student achievements and qualifications;
student interests;
student preferences;
educational venue information such as size and location, and;
educational venue qualifications.

5. The method of claim 1, wherein;
said questions occur in at least two categories,
preference questions, said preference questions eliciting responses indicating said student's preferences, and
requirement questions, said requirement questions eliciting responses indicating said student's requirements for an educational venue.

6. The method of claim 5, wherein;
after said student's score is calculated with respect to each educational venue, educational venues not meeting said student's requirements, as indicated by said student's responses to said requirements questions, are removed from consideration.

7. The method of claim 2, wherein;
when tie scores cause the number of educational venues qualified to be conveyed to said student exceed said predetermined number, a tiebreaker is used to eliminate the necessary number of educational venues to reduce to said predetermined number, said elimination occurring from the lower scoring of the qualified educational venues.

8. The method of claim 6, wherein;
when the number of educational venues meeting said student's requirements is less than a predetermined number of educational venues, at least one of said student's requirements is relaxed to readmit some educational venues and the needed quantity of educational venues is selected from among the top scorers of readmitted educational venues to complete the predetermined number.

9. The method of claim 1, wherein;
said numeric values placed on said questions and on said answers to said questions are limited to the range of 0 through 5.

10. The method of claim 1, wherein;
said educational venues may place numeric values on more than one set of said questions and said answers to said questions to create multiple profiles.

11. A system for measuring the compatibility of potential students and participating educational venues, comprising;
a storage device;
at least one electronic display device;
a processor programmed to;
maintain in said storage device a database containing;
a set of questions,
a specific set of answers to said questions;
information about educational venues;
numeric ratings assigned to each said question and each said answer by each said educational venue;
information about potential students;
answers to said questions selected by said potential students;
display said questions on said at least one electronic display device for said educational venues to create profiles by assigning said numerical ratings to said questions and answers;
for each said educational venue, determining a normalized question value for each said question by dividing the value assigned to said question by said educational venue by the sum of all the values assigned to said questions by said educational venue;
for each said educational venue, determining a normalized answer value for each said answer by dividing the value assigned to said answer by said educational venue by the sum of all the values assigned to said answers to a respective question by said educational venue;
display said questions on said at least one electronic display device for a potential student to select an answer to each said question;
calculate a score for said student for each said educational venue by summing the products of the normalized question value for each said question multiplied by the normalized answer value of each answer selected for a respective question by said student, and;
rank the educational venues by this score, and;
at least one electronic communication device for communicating with said processor.

12. The system of claim 11, wherein;
said processor is also programmed to convey to the student the identities of a predetermined number of educational venues at the top of the rankings based on the student's scores.

13. The system of claim 11, wherein;
said processor is also programmed to convey to said predetermined number of said educational venues at the top of the rankings, the student's identity and contact information.

14. The system of claim 11, wherein;
said processor is also programmed to break a tie between educational venues if a tie results in more than said predetermined number of educational venues being eligible for conveyance to said student.

15. The system of claim 11, wherein;
said questions occur in at least two categories,
preference questions, said preference questions eliciting responses indicating said student's preferences, and
requirement questions, said requirement questions eliciting responses indicating said student's requirements for an educational venue.

16. The system of claim 15, wherein;
said processor is also programmed to eliminate from contention educational venues which do not meet said student requirements.

17. The system of claim 16, wherein;
said processor is also programmed to relax student requirements if more educational venues are needed for consideration.

18. The system of claim 11, wherein;
said processor communicates with said at least one electronic display device and said at least one electronic communication device over a network.

19. The system of claim 18, wherein;
said network is the Internet.

20. The system of claim 11, wherein;
said students and said educational venues use different electronic display devices and electronic communication devices.

21. The system of claim 11, wherein;
said numeric values placed on said questions and on said answers to said questions are limited to the range of 0 through 5.

22. A computer-readable medium having computer-executable instructions for performing a method comprising:
presenting a set of questions and a specific set of answers to each of said questions to a group of participating educational venues;
having each said educational venue place a numeric value on each said question and a numeric value on each said answer to each said question;
for each said educational venue, determining a normalized question value for each said question by dividing the value assigned to said question by said educational venue by the sum of all the values assigned to said questions by said educational venue;
for each said educational venue, determining a normalized answer value for each said answer by dividing the value assigned to said answer by said educational venue by the sum of all the values assigned to said answers to a respective question;
having a potential student respond to said set of questions;
calculating a score for said student for each said educational venue by summing the products of the normalized question value for each said question multiplied by the normalized answer value of each answer selected for a respective question by said student, and;
ranking the educational venues by this score.
